(19) United States
(12) Patent Application Publication
(10) Pub. No.: US 2013/0194805 A1
(43) Pub. Date: Aug. 1, 2013

(54) LED LIGHTING STRUCTURE

(71) Applicants: Ching Feng LIN, Taipei County (TW); Yung HAN, Taipei County (TW)

(72) Inventors: Ching Feng LIN, Taipei County (TW); Yung HAN, Taipei County (TW)

(73) Assignee: JADE YANG CO., LTD., New Taipei City (TW)

(21) Appl. No.: 13/362,715

(22) Filed: Jan. 31, 2012

(51) Int. Cl. F21V 21/14; F21V 21/00

(52) U.S. Cl. 362/249.03; 362/249.02

(57) ABSTRACT

The present invention relates to an LED lighting structure, which includes a plurality of lighting units arranged and mounted to a base. Each lighting unit includes a seat, which has a surface to which a plurality of heat dissipation fins is mounted and an opposite surface to which a circuit board is attached. The circuit board includes a plurality of light-emitting diodes. The lighting units are arranged to allow the light-emitting diodes to face outward. In this way, all the light can be projected outward or toward a direction where lighting is desired so that no light would be wasted and the lighting efficiency and the convenience of use are improved.

### BACKGROUND OF THE INVENTION

1. Field of the Invention

The present invention is related to an LED (Light-Emitting Diode) lighting structure, and more particular to a lamp tube like lighting structure that is formed by arranging a plurality of illumination units.

2. Description of Related Art

A regular elongate circular-section lamp tube or a regular spherical lamp bulb, when lit, allows light to scatter around for illuminating the surroundings. When a site to be illuminated in only located at a specific direction, the scattering light cannot be focused on such a site, making the light going in other directions a waste.

Power-saving lamp tube assembly that is formed of multiple lamp tubes are commonly available for various arrangements, such as two lamp tubes juxtaposing each other, three U-shaped lamp tubes arranged inside a circular head, or four lamp tubes arranged in a rectangular head. Further, spiral lamp tubes are also known. When a combination of multiple lap tubes give off light, the light is similarly scattered around. The light that goes outward provides the desired outside illumination, but the light scattered inside the lamp tubes is blocked by the adjacent tubes and cannot be projected outward, leading to a waste of the light and reducing the utilization efficiency of the light source. This also applies to the spiral lamp tubes, for the light scattering on an inner side of the tubes is blocked by the adjacent tubes and cannot be completely projected outward, leading to a waste of the light source and a poor lighting efficiency. Thus, the conventional lighting structure of the lamp tube must be improved.

### SUMMARY OF THE INVENTION

The primary objective of the present invention is to provide an LED lighting structure, which comprises a plurality of lighting units showing a specific direction of light projection that is arranged to allow the lights of the lighting units to be projected to a direction where lighting is desired or outward so that all the lights can be guided toward the direction where illumination is desired or outward, whereby no light would be wasted and the lighting efficiency is improved.

To achieve the above objective, the LED lighting structure according to the present invention comprises a plurality of lighting units that is arranged and mounted to at least one base, each of the lighting units comprises a seat, the seat having a surface to which a circuit board that is electrically connected to the base is attached, the circuit board comprising a plurality of light-emitting diodes, wherein the arrangement of the lighting units allows the light-emitting diodes all facing outward.

According to an embodiment of the present invention, each seat has an opposite surface to which a plurality of heat dissipation fins is mounted. The plurality of lighting units is arranged to have the light-emitting diodes facing outward, while the heat dissipation fins are arranged at an inner side. As such, when the light-emitting diodes emit light, the light is projected outward and does not travel to the inner sides of the seats, so that no light is wasted and the lighting efficiency and the convenience of use are significantly improved. Further, each of the lighting units comprises a cover, which is mounted to the seat and is located above and houses the circuit board and the light-emitting diode.

According to another embodiment of the present invention, the lighting structure comprises a single cover, which is fixed to the base and houses the plurality of lighting units.

### BRIEF DESCRIPTION OF THE DRAWINGS

The present invention can be fully understood from the following detailed description and preferred embodiments with reference to the accompanying drawings, in which:

FIG. 1 is a perspective view showing a first embodiment of the present invention in an assembled form;

FIG. 2 is an exploded view of a lighting unit of the first embodiment of the present invention;

FIG. 3 is a cross-sectional view of the first embodiment of the present invention;

FIG. 4 is a cross-sectional view of a second embodiment of the present invention; and

FIG. 5 is a perspective view of a third embodiment of the present invention in an assembled form.

### DETAILED DESCRIPTION OF THE PREFERRED EMBODIMENTS

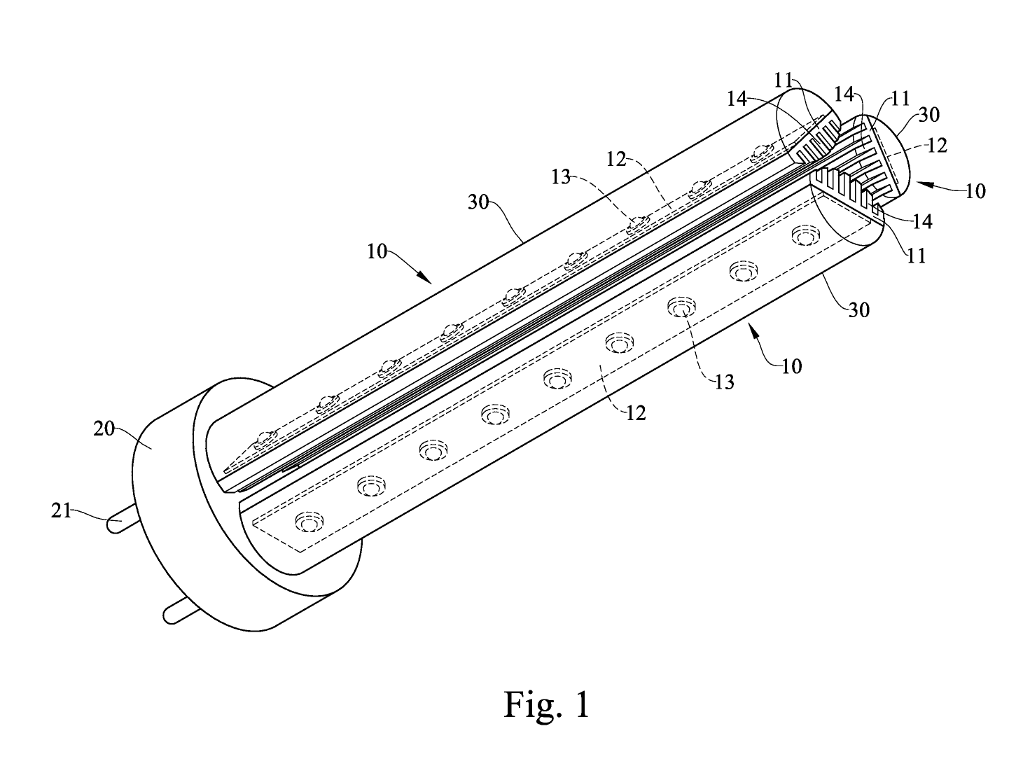

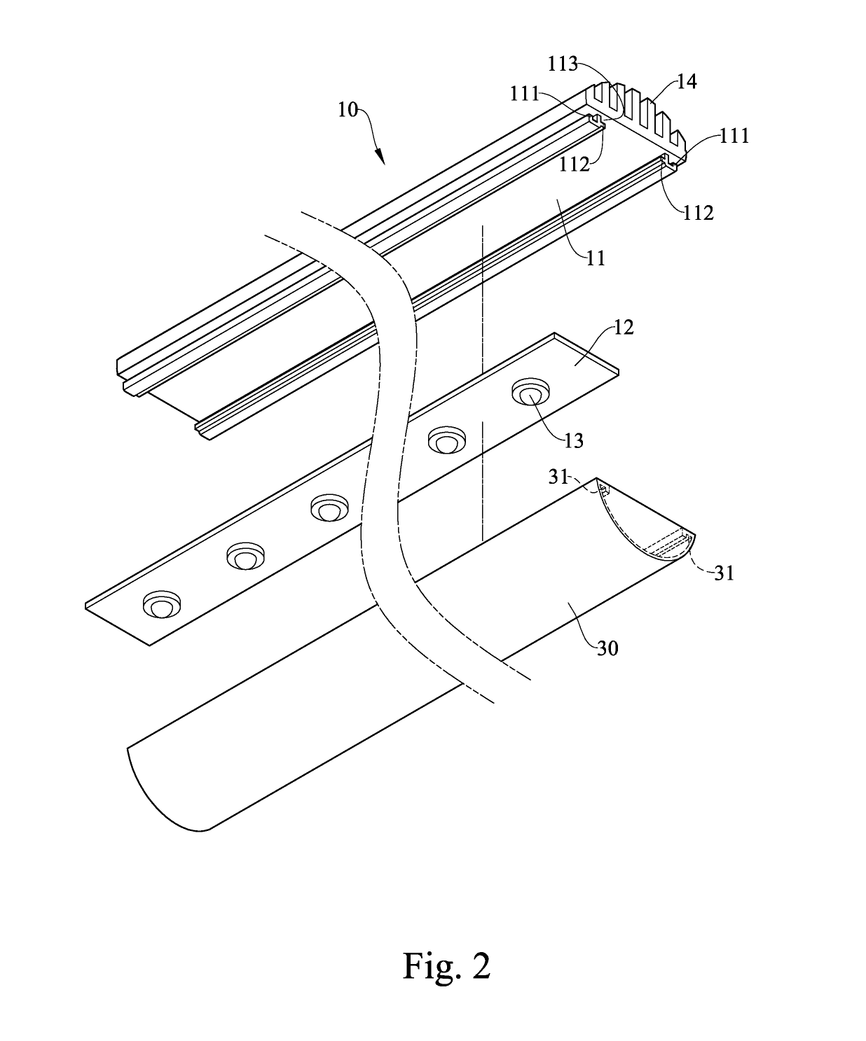

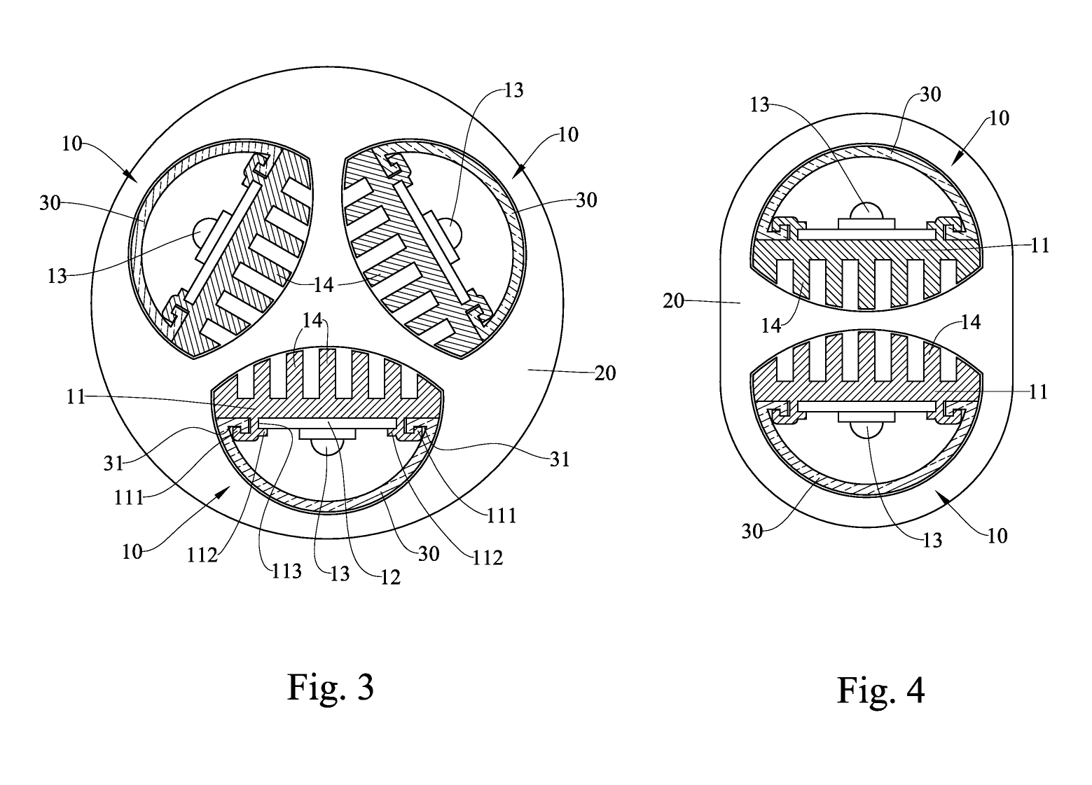

With reference to FIGS. 1-3, which are respectively a perspective view showing a first embodiment of the present invention in an assembled form, an exploded view and a cross-sectional view of a lighting unit, the LED lighting structure according to the present invention comprises three lighting units 10 that mounted in an upright manner on a circular base 20. Each of the lighting units 10 comprises a seat 11, which has a surface to which a circuit board 12 is attached. The circuit board 12 comprises a plurality of light-emitting diodes 13 mounted thereon. The lighting units 10 are arranged to form a circle with the light-emitting diodes 13 facing outward. Each of the seats 11 has an opposite surface to which a plurality of heat dissipation fins 14 is mounted. The heat dissipation fins 14 are arranged in an opposing manner and are located on an inner side of the lighting unit 10. The heat dissipation fins 14 can be integrally formed on the seat 11. Each of the lighting units 10 is housed by a cover 30 with the cover 30 being mounted to the surface of the seat 11 and located above and covering the circuit board 12 and the light-emitting diode 13.

The cover 30 is a hollow semi-cylinder made of plastic molding and has two edge flanges that are recessed to each form a slot rail 31. The seat 11 is also formed of a plastic molding and forms two hooks 111 respectively extending along two edges of the surface thereof to which the circuit board 12 is attached for being slidably and respectively received in and engaging the slot rails 31 of the cover 30. The two hooks 111 have opposing inside faces on which projection ribs 112 are formed to oppose each other. Each projection rib forms a receiving channel 113 with the seat 11, whereby the circuit board 12 is received in the receiving channels 113 and thus attached to the seat 11. Each of the lighting units 10 has an end mounted to the base 20 and the circuit board 12 is electrically connected to the base 20. The base 20 is provided with terminals 21 for engaging an external power supply. The plurality of lighting units 10 can be connected in series or in parallel.

With the above described arrangement, the three lighting units 10 are arranged to form a circle and the heat dissipation fins 14 are oriented inward of the lighting unit 10, while the light-emitting diodes 13 face outward. In the way, when the light-emitting diodes 13 are lit, the light emitting from the light-emitting diodes is completely projected outward with substantially no light traveling to the inner sides of the seats 11. Light energy will not be wasted and the lighting efficiency is significantly improved.

The quantity of the lighting units 10 used in the present invention is not limited to three and any combination of two or more than two light units can be used with the light-emitting diode 13 oriented outward and the heat dissipation fins 14 facing inward of the lighting units 10, thereby ensuring all the light emitting from the lighting units 10 is substantially projected outward and is thus fully used. As shown in FIG. 4, which is a cross-sectional view of a second embodiment of the present invention, two lighting units 10 are mounted on a base 20. The lighting units 10 are identical to the lighting units 10 of the first embodiment. The two lighting units 10 are arranged opposite to each other, whereby the covers 30 and the light-emitting diodes 13 are oriented outward and the heat dissipation fins 14 of the seats 11 oriented inward in order not to project light inward and thus eliminating waste of light and improving lighting efficiency.

Further, the lighting units 10 can be arranged in a geometric shape other than circle. For example, if desired, the lighting units can be arranged to form various shapes, such as a square or an arc, provided the light-emitting diodes 13 are oriented to the direction where illumination is desired so that the light can be fully used and the performance is improved.

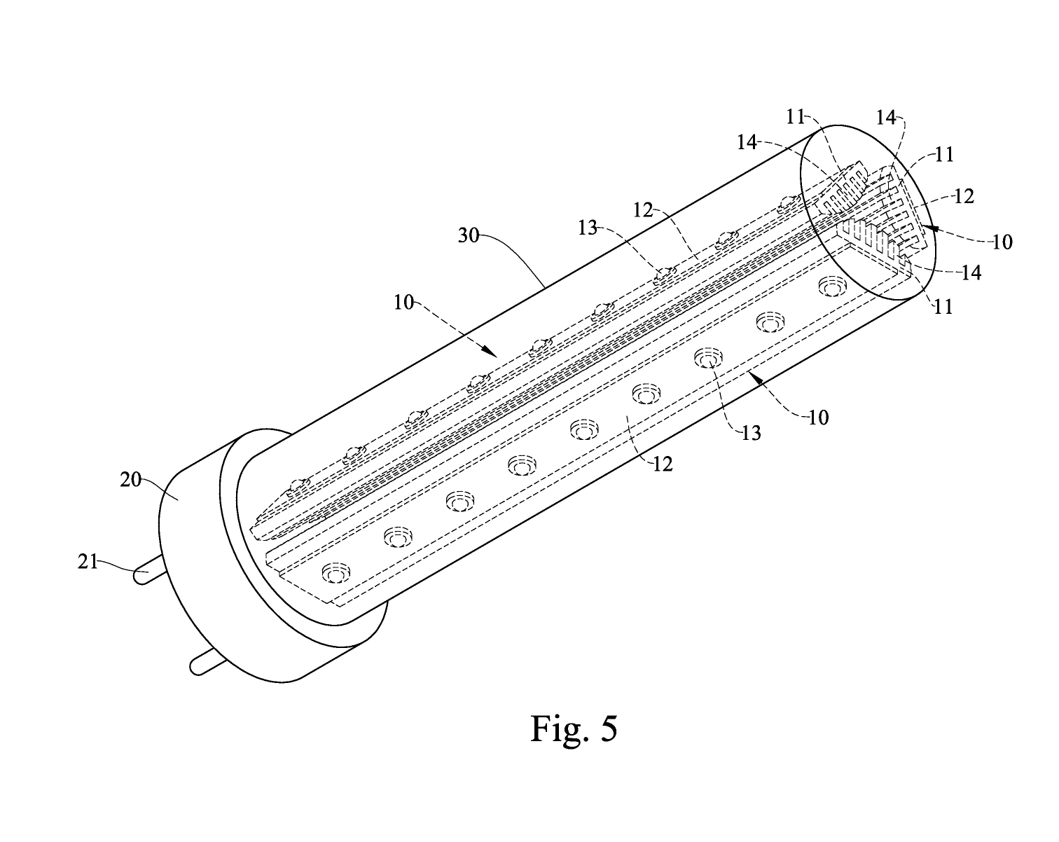

Referring to FIG. 5, which shows a third embodiment of the present invention, the third embodiment comprises three lighting units 10 that are mounted to a circular base 20. Each lighting unit 10 similarly comprises a seat 11, and a circuit board 12 is attached on a surface of the seat 11. The circuit board 12 comprises a plurality of light-emitting diodes 13. The lighting units 10 are arranged to form a circle with the light-emitting diodes 13 facing outward. Each of the seats 11 has an opposite surface forming a plurality of heat dissipation fins 14, and the heat dissipation fins 14 are oriented inwardly of the lighting units 10. The difference between the instant embodiment and the first embodiment is the cover 30. In the instant embodiment, only one cover 30 is included and the single cover 30 is mounted to base 20 and houses all the lighting units 10.

Further, the heat dissipation fins 14 of each embodiment according to the present invention can be integrally formed with the seat 11, or alternatively, the heat dissipation fins 14 can be made as a separate heat dissipation fin assembly (not shown) that is mounted to the seat 11 of each lighting unit 10 so that an illumination gap of each lighting unit 10 can be reduced.

In summary, the LED lighting structure according to the present invention comprises a plurality of lighting units that are arranged in such a way that the light-emitting diode contained in the lighting units are oriented toward the direction where illumination is desired in order to control the direction of light and thus fully use the light to improve the lighting efficiency.

What is claimed is:

1. An LED lighting structure, which comprises a plurality of lighting units that is arranged and mounted on at least one base, each of the lighting units comprises a seat, the seat having a surface to which a circuit board that is electrically connected to the base is attached, the circuit board comprising a plurality of light-emitting diodes, wherein the arrangement of the lighting units allows the light-emitting diodes all facing outward.

2. The LED lighting structure according to claim 1, wherein each of seats of the lighting units has an opposite surface to which a plurality of heat dissipation fins is mounted.

3. The LED lighting structure according to claim 1, wherein the seat of each of the lighting units has an opposite surface opposing each other and located at an inner side of the lighting unit.

4. The LED lighting structure according to claim 2, wherein the seat of each of the lighting units has an opposite surface opposing each other and located at an inner side of the lighting unit.

5. The LED lighting structure according to claim 1, wherein each of the lighting units comprises a cover, the cover being mounted to the seat and located above and housing the circuit board and the light-emitting diodes.

6. The LED lighting structure according to claim 5, wherein the cover comprises a hollow semi-cylinder having two edge flanges each of which is recessed to form a slot rail, each seat forming hooks respectively extending along two edges of the surface thereof to which the circuit board is attached, the slot rails formed in the two edge flanges of the cover slidably and respectively receiving and engaging the hooks.

7. The LED lighting structure according to claim 6, wherein the two hooks having inside faces on which projection ribs are formed to oppose each other, each of the projection ribs forming a receiving channel with the seat, the circuit board being received in and fixed in the receiving channels.

8. The LED lighting structure according to claim 1, wherein the base comprises a cover mounted thereto, the cover housing the plurality of lighting units.

9. The LED lighting structure according to claim 2, wherein the plurality of heat dissipation fins mounted to said opposite surface of each of the seats of the lighting units is integrally formed as a unitary heat dissipation fin assembly, the heat dissipation fin assembly being mounted to the seat of the lighting unit.
